(19) United States
(12) Patent Application Publication
(10) Pub. No.: US 2022/0080317 A1
(43) Pub. Date: Mar. 17, 2022

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Takamasa SHIBA, Tokyo (JP); Hiroshi KOBAYASHI, Tokyo (JP); Jun WAGA, Tokyo (JP); Yutaka YOSHIDA, Tokyo (JP)

(73) Assignee: SQUARE ENIX CO., LTD., Tokyo (JP)

(21) Appl. No.: 17/447,220

(22) Filed: Sep. 9, 2021

(30) Foreign Application Priority Data
Sep. 11, 2020 (JP) 2020-152734

(51) Int. Cl. A63F 13/57; A63F 13/537

(52) U.S. Cl. CPC A63F 13/57; A63F 13/537

(57) ABSTRACT

A non-transitory computer-readable medium including a video game processing program for causing a server to perform functions to control progress of a video game using positional information of a user terminal in response to a user operation is provided. The functions include: a determining function configured to determine a planned arranging position for an event object corresponding to an event selected based on the user operation in a virtual space corresponding to map information on a real space; a changing function configured to change a position at which the event object is arranged or a position of as existing object already arranged on the basis of the planned arranging position; and a generating function configured to generate an event is accordance with a positional condition regarding a position of the user terminal and the position of the event object or the position of the existing object.

### CROSS-REFERENCE TO RELATED APPLICATION

The present application claims priority to and the benefit of Japanese Patent Application No. 2020-152734 filed on Sep. 11, 2020, the disclosure of which is expressly incorporated herein by reference in its entirety for any purpose.

### BACKGROUND

At least one of embodiments of the present disclosure relates to a non-transitory computer-readable medium including a video game processing program and a video game processing system for causing a server to perform functions to control progress of a video game using positional information of a user terminal in response to an operation of a user.

In recent years, various systems each using positional information of a user terminal have been proposed in a field of video games.

In such a system, there is one in which a score of a user is calculated on the basis of a score map in which a score area is set in accordance with a position in a real space and positional information for specifying a position of a mobile object (for example, a user terminal). Examples of such system may be found in Japanese Patent Application Publication No. 2002-95865.

### SUMMARY

Now, in a conventional system using positional information of a user terminal, in a case where an object is to be arranged in a virtual space corresponding to map information on a real space, the object is arranged at a position defined in advance. Even in a case where the position is changed, intention of a user is not reflected. For that reason, the user may get tired of a configuration of the virtual space. As a result, interest of the user in a video game may be decreased.

It is an object of at least one of embodiments of the present disclosure to solve the problem described above, and to prevent interest of a user in a video game from being decreased.

According to one non-limiting aspect of the present disclosure, there is provided a non-transitory computer-readable medium including a video game processing program for causing a server to perform functions to control progress of a video game using positional information of a user terminal of a user in response to a user operation.

The functions include a determining function configured to determine a planned arranging position for an event object corresponding to an event in a virtual space corresponding to map information on a real space, the event being selected on a basis of the user operation, the planned arranging position for the event object being a position at which the event object is planned to be arranged.

The functions also include a changing function configured to change a position at which the event object is to be arranged or a position of an existing object on the basis of the planned arranging position, the existing object having already been arranged.

The functions also include a generating function configured to generate an event in accordance with a positional condition regarding a position of the user terminal and the position of the event object or the position of the existing object.

According to another non-limiting aspect of the present disclosure, there is provided a video game processing system for controlling progress of a video game using positional information of a user terminal of a user in response to a user operation. The video game processing system includes a communication network, a server, and the user terminal.

The video game processing system includes a determiner configured to determine a planned arranging position for an event object corresponding to an event in a virtual space corresponding to map information on a real space, the event being selected on a basis of the user operation, the planned arranging position for the event object being a position at which the event object is planned to be arranged.

The video game processing system also includes a changer configured to change a position at which the event object is to be arranged or a position of an existing object on a basis of the planned arranging position, the existing object having already been arranged.

The video game processing system also includes a generator configured to generate an event in accordance with a positional condition regarding a position of the user terminal and the position of the event object or the position of the existing object.

According to still another non-limiting aspect of the present disclosure, there is provided a non-transitory computer-readable medium including a video game processing program for causing a user terminal to perform functions to control progress of a video game using positional information of a user terminal of a user in response to the user operation.

The functions include a determining function configured to determine a planned arranging position for an event object corresponding to an event in a virtual space corresponding to map information on a real space, the event being selected on a basis of the user operation, the planned arranging position for the event object being a position at which the event object is planned to be arranged.

The functions also include a changing function configured to change a position at which the event object is to be arranged or a position of an existing object on a basis of the planned arranging position, the existing object having already been arranged.

The functions also include a generating function configured to generate an event in accordance with a positional condition regarding a position of the user terminal and the position of the event object or the position of the existing object.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description of preferred embodiments of the present disclosure that proceeds with reference to the appending drawings:

FIG. 1 is a block diagram illustrating an example of a configuration of a video game processing system. corresponding to at least one of the embodiments of the present disclosure;

FIG. 2 is a block diagram illustrating a configuration of a server corresponding to at least one of the embodiments of the present disclosure;

FIG. 3 is a flowchart illustrating an example of game processing corresponding to at least one of the embodiments of the present disclosure;

FIG. 4 is a flowchart illustrating an example of an operation of a server side in the game processing corresponding to at least one of the embodiments of the present disclosure;

FIG. 5 is a flowchart illustrating an example of an operation of a terminal side in the game processing corresponding to at least one of the embodiments of the present disclosure;

FIG. 6 is a block diagram illustrating a configuration of a server corresponding to at least one of the embodiments of the present disclosure;

FIG. 7 is a flowchart illustrating an example of game processing corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of game processing corresponding to at least one of the embodiments of the present disclosure;

FIG. 10 is a block diagram illustrating a configuration of a server corresponding to at least one of the embodiments of the present disclosure;

FIG. 11 is a flowchart illustrating an example of game processing corresponding to at least one of the embodiments of the present disclosure;

FIG. 12 is a block diagram illustrating a configuration of a server corresponding to at least one of the embodiments of the present disclosure;

FIG. 13 is a flowchart illustrating an example of game processing corresponding to at least one of the embodiments of the present disclosure;

FIG. 14 is a block diagram illustrating a configuration of a server corresponding to at least one of the embodiments of the present disclosure;

FIG. 15 is an explanatory drawing for explaining an example of a storage state of information corresponding to at least one of the embodiments of the present disclosure;

FIG. 16 is an explanatory drawing for explaining an example of a storage state of information corresponding to at least one of the embodiments of the present disclosure;

FIG. 17 is a flowchart illustrating an example of game processing corresponding to at least one of the embodiments of the present disclosure;

FIG. 18 is an explanatory drawing illustrating another example of the display screen corresponding to at least one of the embodiments of the present disclosure; and

FIG. 19 is an explanatory drawing illustrating an example of a display screen corresponding to at least one of the embodiments of the present disclosure.

### DETAILED DESCRIPTION

Hereinafter, examples of embodiments according to the present disclosure will be described with reference to the drawings. Note that various components in the respective embodiments described below can be appropriately combined without any contradiction or the like. In addition, the description of the content described as a certain embodiment may be omitted in another embodiment. Further, the content of an operation or processing that does not relate to features of each of the embodiments may be omitted. Moreover, the order of various processes that constitute various flows described below may be changed without any contradiction or the like of processing content.

### First Embodiment

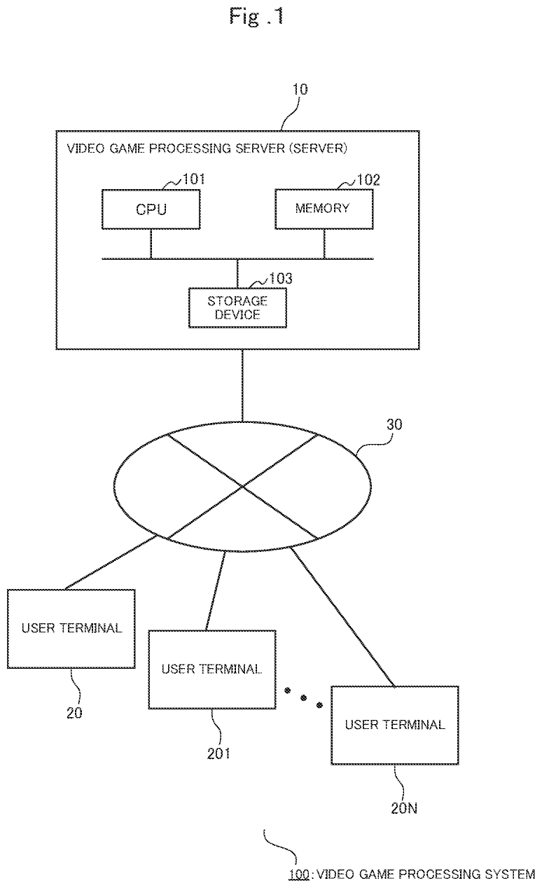

FIG. 1 is a block diagram illustrating an example of a configuration of a video game processing system 100 according to one embodiment of the present disclosure. As illustrated in FIG. 1, the video game processing system 100 includes a video game processing server 10 (hereinafter, referred to as a “server 10”) and user terminals 20, and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by executing data communication with base stations managed by a telecommunication carrier by means of a radio communication line.

The video game processing system 100 includes the server 10 and the plurality of user terminals 20 and 201 to 20N, whereby various kinds of functions for executing various kinds of processing in response to an operation of the user are performed.

The server 10 is managed by an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. A configuration of the server 10 is not limited particularly so long as the server 10 includes a general configuration for executing various kinds of processes as a computer, such as a control unit and a communication unit. Hereinafter, an example of a hardware configuration of the server 10 will be described briefly.

As illustrated in FIG. 1, the server 10 at least includes a CPU (Central Processing Unit) 101, a memory 102, and a storage device 103.

The CPU 101 is a central processing unit configured to execute various kinds of calculations and controls. Further, in a case where the server 10 includes a GPU (Graphics Processing Unit), a part of the various kinds of calculations and controls may be executed by the GPU. The server 10 appropriately executes, by the CPU 101, various kinds of information processing required to control a video game by using data read out onto the memory 102, and stores obtained processing results in the storage device 103 as needed.

The storage device 103 has a function as a storage medium for storing various kinds of information. A configuration of the storage device 103 is not limited particularly. However, it is preferable that the storage device 103 is configured so as to be capable of storing all of the various kinds of information required to control the video game from the viewpoint of reducing a processing load on each of the plurality of user terminals 20 and 201 to 20N. As such examples, there are an HDD and an SSD. However, a storage unit for storing the various kinds of information may be provided with a storage region in a state that the server 10 can access the storage region, for example, and may be configured so as to have a dedicated storage region outside the server 10.

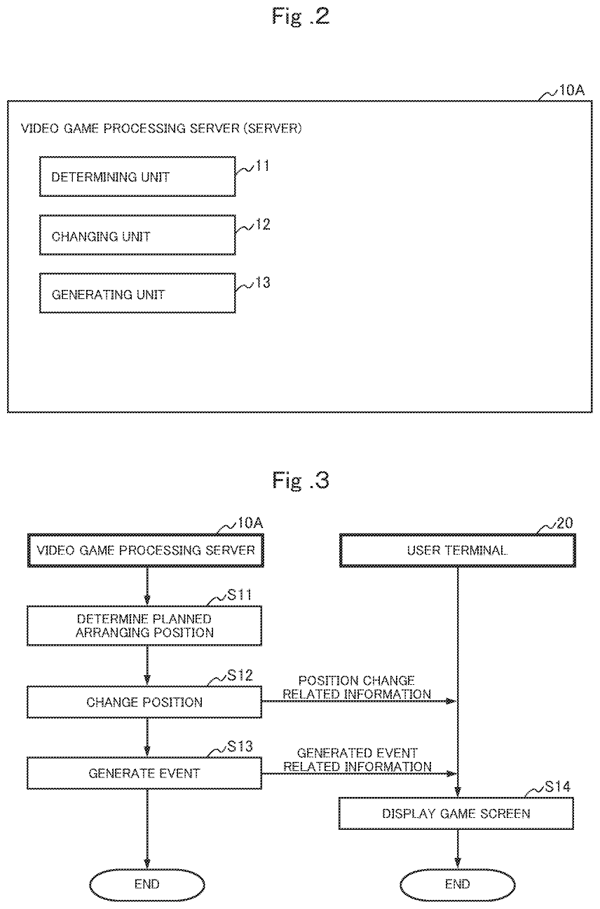

FIG. 2 is a block diagram illustrating a configuration of a video game processing server 10A (hereinafter, referred to as a “server 10A”), which is an example of the configuration of the server 10. As illustrated in FIG. 2, the server 10A at least includes a determining unit 11, a changing unit 12, and a generating unit 13.

The determining unit 11 has a function to determine a planned arranging position for an event object corresponding to an event that is selected on the basis of a uses operation in a virtual space corresponding to map information on a real space. The planned arranging position for the event object means a position at which the event object is planned to be arranged.

Here, the virtual space corresponding to the map information of the real space means a virtual space that is generated by using the map information of the real space. A configuration to generate the virtual space is not limited particularly. However, it is preferable that the determining unit 11 is configured so that the user can recognize that the virtual space is generated on the basis of the map information of the real space. As an example of such a configuration, there is a configuration in which the virtual space is generated by respectively arranging objects corresponding to roads and buildings in the real space at positions corresponding to roads and buildings in the real space. In this regard, a configuration of the object corresponding to each of the roads and the buildings in the real space is not limited particularly. However, it is preferable that the object is configured so that the user can recognize that it has a correspondence relationship with a road, a building, or the like. As examples of such a configuration, there are an object created to resemble the appearance of a road and an object (for example, a character) different from objects that constitute the virtual space (for example, the ground). Further, a configuration to associate the position in the real space with the position in the virtual space is not limited particularly. However, the generating unit 12 may be configured so that a coordinate in the real space and a coordinate in the virtual space are defined in a one-to-one relationship, or may be configured so that the coordinates are defined in a plural-to-one relationship or a one-to-plural relationship.

Further, the user operation means an input operation to the user terminal 20 by the user. The user operation is not limited particularly. However, it is preferable that the user operation is an input operation for selection by the user. As an example of the user operation, there is an input operation in which information displayed on a game screen is selected.

Further, a configuration to select an event on the basis of the user operation is not limited particularly. However, it is preferable that the determining unit 11 is configured so that the user can recognize which event is selected. As an example of the configuration to select an event on the basis of the user operation, there is a configuration in which the user terminal 20 is caused to display information regarding a plurality of events, and a user is caused to select and input any event on the basis of the displayed information.

Further, the event means any of various kinds of occurrences that can be generated in the video game. A configuration of the event is not limited particularly. However, it is preferable that the event is configured so as to be generated in a case where a generation condition is satisfied in a virtual space corresponding to map information on a real space in accordance with progress of the video game. As an example of the event, there is an event associated with an object that is arranged in a virtual space corresponding to map information on a real space. In this regard, as examples of the event corresponding to the object, there are various kinds of events associated with a type of object.

Further, the event object means an object corresponding to an event and related to the event. Further, the object means a virtual object or subject that appears in the video game. The event object is not limited particularly. However, it is preferable that the event object has appearance related to the event. As an example of the event object, there is an event object that indicates a place related to a corresponding event (for example, a town or a dungeon).

Further, the planned arranging position for the event object means a position where the event object is planned to be arranged in the virtual space. The planned arranging position for the event object is not limited particularly. However, it is preferable that the planned arranging position for the event object is a position that the user can recognize. As an example of the planned arranging position for the event object, there is a position that is defined on the basis of information regarding the event object. Further, the phrase “the object that is arranged” means that the object is associated with a position in the virtual space. A configuration to arrange the object is not limited particularly. However, it is preferable that the determining unit 11 is configured so as to arrange an object so that the object can be displayed on a display screen of the user terminal 20 in a case where a position at which the object is arranged or an area corresponding to the object and including the position is included in a display area of the user terminal 20.

The changing unit 12 has a function to change a position at which the event object is to be arranged or a position of an existing object, which has already been arranged, on the basis of the planned arranging position.

Here, the existing object means an object that has already been arranged and is different from the event object. The existing object is not limited particularly. However, it is preferable that the existing object is an object whose type or appearance is different from that of the event object. As examples of the existing object, there are a character itself of a user, an object that generates an event affecting the character of the user, an item that can be owned by the user, and a building that is installed by the user. In this regard, the existing object may be the same type of object as the event object.

Further, the phrase “change a position at which the event object is to be arranged or a position of an existing object” means that a position associated with the event object or the existing object is changed. A configuration to change the position at which the event object is to be arranged or the position of the existing object is not limited particularly. However, it is preferable that the changing unit 12 is configured so as to specify a position after change in accordance with a predetermined change rule. As an example of the configuration to change the position at which the event object is to be arranged or the position of the existing object, there is a configuration in which a position after change is specified in accordance with a change rule based on a positional relationship between an event object and an existing object. As an example of such a configuration, there is a configuration in which one position is not changed and the other position is changed into a short distance from the one position so as not to sandwich the other object therebetween. By configuring the changing unit 12 in this manner, it is possible to prevent the other position from being changed largely so much that the developer and the like do not expect it.

The generating unit 13 has a function to generate an event in accordance with a positional condition regarding a position of the user terminal 20 and the position of the event object or the position of the existing object.

Here, the position of the user terminal 20 means a position indicated by positional information of the user terminal 20. A configuration of the positional information is not limited particularly. However, it is preferable that the positional information is configured so as to contain coordinates that can specify the position of the user terminal 20 in the real space. As examples of the configuration to obtain the positional information of the user terminal 20, there are a configuration to obtain the positional information by using a GPS signal, and a configuration to obtain the positional information on the basis of reception intensity information of wireless signals from a plurality of beacon transmitters.

Further, the positional condition regarding the position of the user terminal 20 and the position of the event object or the position of the existing object means a condition that includes a state that the position of the user terminal 20 and the position of the arranged event object or the existing object have a predetermined relationship. As an example of the positional condition, there is a condition that a distance between the position of the user terminal 20 and the position of the arranged event object or the existing object is a predetermined length or shorter. In this regard, the event may be configured so as to be generated in a case where a condition other than the positional condition is satisfied. As an example of the condition other than the positional condition, there is a condition that a selection operation against the event object or the existing object is carried out.

Further, the event to be generated in accordance with the positional condition is not limited particularly. However, it is preferable that the event is an event corresponding to the event object or the existing object. As an example of the event corresponding to the existing object, there is an event regarding the character of the user.

Each of the plurality of user terminals 20, and 201 to 20N is managed by the user, and is configured by a communication terminal capable of playing a network delivery type game, such as a cellular telephone terminal, a PDA (Personal Digital As a portable game apparatus, or a so-called wearable device, for example. In this regard, the configuration of the user terminal that the video game processing system 100 can include is not limited to the example described above. Each of the user terminals 20, and 201 to 20N may be configured so that the user can recognize the video game. As the other examples of the user terminal, there are one obtained by combining various kinds of communication terminals, a personal computer, and a stationary game apparatus.

Further, each of the plurality of user terminals 20, and 201 to 20N is connected to the communication network 30, and includes hardware (for example, a display device for displaying a browser screen or a game screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the video game processing system 100 (hereinafter, referred to as the “system 100”) according to the present embodiment will be described.

FIG. 3 is a flowchart illustrating an example of game processing executed by the system 100. In the game processing according to the present embodiment, processes related to a control of progress of the video game using the positional information of the user terminal 20 are executed. Hereinafter, a case where the server 10A and the user terminal 20 (hereinafter, referred to as the “terminal 20”) execute the game processing will be described as an example.

The game processing is started as an opportunity that the terminal 20 accessing the server 10A requests display of a virtual space, for example.

In the game processing, the server 10A first determines a planned arranging position for an event object corresponding to a selected event in a virtual space corresponding to map information of a real space on the basis of a user operation (Step S11). In the present embodiment, the server 10A stores information regarding the planned arranging position thus determined in a predetermined storage region.

When the planned arranging position is determined, the server 10A changes a position at which the event object is to be arranged or a position of an existing object that has already been arranged on the basis of the planned arranging position (Step S12). In the present embodiment, the server 10A transmits, to the terminal 20, position change related information for causing the terminal 20 to display a result of the change related to the change content of the position of the event object or the existing object.

When the position is changed, the server 10A generates an event in accordance with a positional condition regarding a position of the uses: terminal 20, and the position of the event object or the position of the existing object (Step S13). In the present embodiment, the server 10A transmits, to the terminal 20, generated event related information for causing the terminal 20 to display the generation content of the event related to generation of the event.

When the generated event related information is received from the server 10A, the terminal 20 outputs a game screen to a display screen of a predetermined display device (Step S14). In the present embodiment, when the terminal 20 outputs the game screen, the server 10A and the terminal 20 terminate the processes herein.

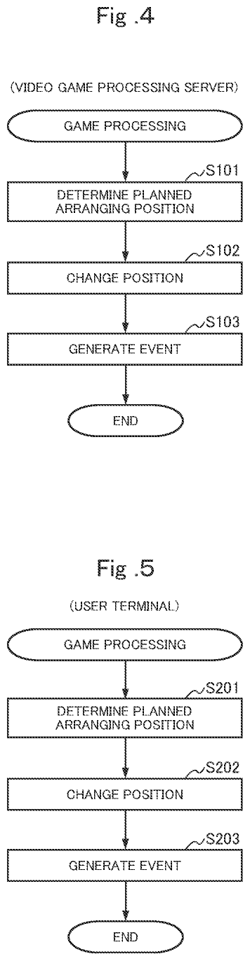

FIG. 4 is a flowchart illustrating an example of an operation of the server 10A side in the game processing. Here, an operation of the server 10A in the system 100 will be described again.

In the game processing, the server 10A first determines a planned arranging position for an event object corresponding to a selected event in a virtual space corresponding to map information of a real space on the basis of a user operation (Step S101); changes a position at which the event object is to be arranged or a position of an existing object that has already been arranged on the basis of the planned arranging position (Step S102); and generates an event in accordance with a positional condition regarding a position of the terminal 20, and the position of the event object or the position of the existing object (Step S103). When the event is generated, the server 10A terminates the processes herein.

FIG. 5 is a flowchart illustrating an example of the terminal 20 side in a case where the terminal 20 executes the game processing. Hereinafter, a case where the terminal 20 executes the game processing by a single body will be described as an example. In this regard, the configuration of the terminal 20 includes the similar functions to those of the server 10A except that the terminal 20 receives various kinds of information from the server 10A. For this reason, its explanation is omitted from a point of view to avoid repeated explanation.

In the game processing, the terminal 20 first therebetween determines a planned arranging position for an event object corresponding to a selected event in a virtual space corresponding to map information of a real space on the basis of a user operation (Step S201); changes a position at which the event object is to be arranged or a position of an existing object that has already been arranged on the basis of the planned arranging position (Step S202); and generates an event in accordance with a positional condition regarding a position of the terminal 20, and the position of the event object or the position of the existing object (Step S203). When the event is generated, the terminal 20 terminates the processes herein.

As explained above, as one aspect of the first embodiment, the server 10A that controls progress of the video game using the virtual space corresponding to the map information of the real space and the positional information of the user terminal is configured so as to include the determining unit 11, the changing unit 12, and the generating unit 13. Thus, the determining unit 11 determines the planned arranging position of the event object corresponding to the event that is selected on the basis of the user operation in the virtual space corresponding to the map information on the real space; the changing unit 12 changes the position at which the event object is to be arranged or the position of the existing object, which has already been arranged, on the basis of the planned arranging position; and the generating unit 13 generates the event in accordance with the positional condition regarding the position of the terminal 20 and the position of the event object or the position of the existing object. Therefore, it becomes possible to prevent interest of the user in the video game from being decreased.

Namely, in the video game using the positional information of the terminal 20, it is possible to reflect intention of the user to the change in the position of the object in the virtual space corresponding to the map information of the real space by arrangement of the object by means of the user operation, and as a result, it becomes possible to prevent the interest of the user in the video game from being decreased. In other words, in the video game using the positional information of the terminal 20, it is possible to cause the user to experience a sense to affect the configuration of the virtual space by the change in the position of the object, and as a result, it becomes possible to cause the user to continuously have interest in the video game.

### Second Embodiment

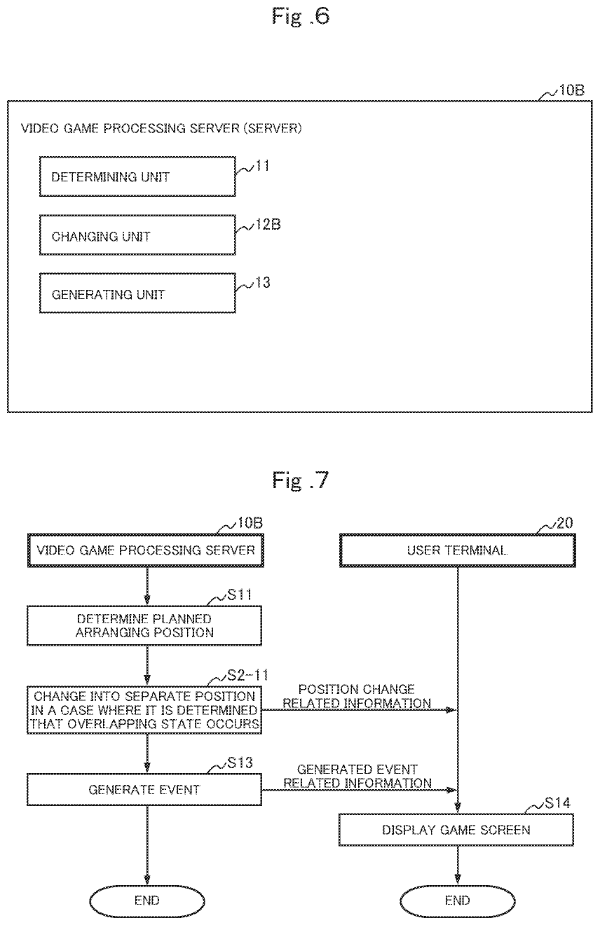

FIG. 6 is a block diagram illustrating a configuration of a video game processing server 10B (hereinafter, referred to as a “server 10B”), which is an example of the video game processing server 10. In the present embodiment, the server 10B at least includes a determining unit 11, a changing unit 12B, and a generating unit 13.

The changing unit 12B has a function to change a position at which an event object is to be arranged or a position of an existing object into a position at which the event object and the existing object are separated from each other on the basis of a planned arranging position in a case where it is determined that a predetermined state where the event object and the existing object are displayed so that at least a part of the event object overlaps with the existing object by displaying the event object at the planned arranging position is generated.

Here, the predetermined state where the event object and the existing object are displayed so that at least a part of the event object overlaps with the existing object (that is, an overlapping state) means a state where at least a part of an area corresponding to the event object overlaps with an area corresponding to the existing object. The overlapping state is not limited particularly. However, it is preferable that the overlapping state is a state that the user can recognize. As examples of the overlapping state, there are a state where display areas of an image of the event object and an image of the existing object overlap with each other on a game screen, a state where at least a part of an area corresponding to the event object on a map in a virtual space exists within at least a part of an area corresponding to the existing object in the virtual space, and a state where at least a part of one object is hidden by at least a part of the other object. In this regard, as an example of a configuration to determine whether the overlapping state is generated or not, there is a configuration in which it is determined that an overlapping state is generated in a case where a distance between a reference position (or a coordinate) of the event object and a reference position (or a coordinate) of the existing object is a predetermined distance or shorter.

Further, the phrase “the event object and the existing object are separated from each other” means that a distance between the event object and the existing object increases. A configuration to set two objects to a separating state is not limited particularly. The changing unit 12B may be configured so as to separate drawing areas of the two objects from each other, or may be configured so as to separate parts respectively constituting the two objects (for example, coordinates that become reference positions for each other) from each other. As examples of the configuration to set the two objects to the separating state, there are a configuration in which drawing areas of two objects do not overlap with each other, and a configuration in which parts respectively constituting two objects (for example, coordinates that become reference positions for each other) are separated from each other so as not to sandwich the other object therebetween.

FIG. 7 is a flowchart illustrating an example of game processing executed by a video game processing system 100. Hereinafter, operations of the server 10B and a user terminal 20 (hereinafter, referred to as a “terminal 20”) will be described as an example. In this regard, a flowchart illustrating an operation of each of the server 10B and the terminal 20 is omitted from a point of view to avoid repeated explanation.

When a planned arranging position is determined, the server 10B changes a position at which an event object is to be arranged or a position of an existing object into a position at which the event object and the existing object are separated from each other on the basis of a planned arranging position in a case where it is determined that a predetermined state where the event object and the existing object are displayed so that at least a part of the event object overlaps with the existing object by displaying the event object at the planned arranging position is generated (Step S2-11). In the present embodiment, the server 10B transmits, to the terminal 20, position change related information for causing the terminal 20 to display a result of the change related to the change content of the position of the event object or the existing object.

As explained above, as one aspect of the second embodiment, the server 10B that controls progress of a video game using the virtual space corresponding to the map information of the real space and the positional information of the user terminal is configured so as to include the determining unit 11, the changing unit 12B, and the generating unit 13. Thus, the changing unit 12B changes the position at which the event object is to be arranged or the position of the existing object into the position at which the event object and the existing object are separated from each other on the basis of the planned arranging position in a case where it is determined that the predetermined state where the event object and the existing object are displayed so that at least the part of the event object overlaps with the existing object by displaying the event object at the planned arranging position is generated. Therefore, it is possible to improve visibility of a displayed object from the user. Further, for example, in a case where the user carries out an operation to directly select the displayed object, it is possible to reduce a possibility that the user carries out an operation to select an object that is not intended to be selected from two objects (that is, a wrong operation). Therefore, it becomes possible to improve operability.

### Third Embodiment

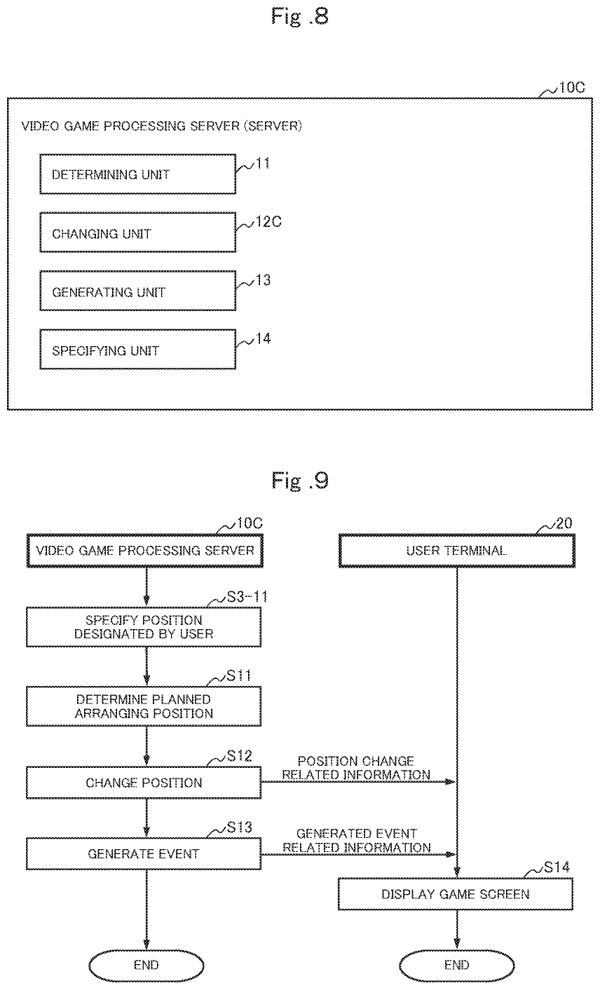

FIG. 8 is a block diagram illustrating a configuration of a video game processing server 10C (hereinafter, referred to as a “server 10C”), which is an example of the video game processing server 10. In the present embodiment, the server 10C at least includes a determining unit 11, a changing unit 12C, a generating unit 13, and a specifying unit 14.

The specifying unit 14 has a function to specify a position in a virtual space that is designated by a user as a planned arranging position.

Here, the phrase “a position in a virtual space is designated by a user” means that any position in the virtual space is defined on the basis of a user operation. A configuration that the user designates the position in the virtual space is not limited particularly. However, it is preferable that the specifying unit 14 is configured so that the user is caused to select any position from positions that can be designated in the virtual space by the user. As an example of the configuration that the user designates the position in the virtual space, there is a configuration in which a user is caused to select any spot on a map corresponding to a virtual space.

The changing unit 12C has a function to change a position at which an event object is to be arranged or a position of an existing object on the basis of the specified planned arranging position.

FIG. 9 is a flowchart illustrating an example of game processing executed by a video game processing system 100. Hereinafter, operations of the server 10C and a user terminal 20 (hereinafter, referred to as a “terminal 20”) will be described. as an example. In this regard, a flowchart illustrating an operation of each of the server 10C and the terminal 20 is omitted from a point of view to avoid repeated explanation.

In the game processing, the server 10C first specifies a position in a virtual space that is designated by the user as a planned arranging position (Step S3-11). In the present embodiment, the server 10C stores information regarding the planned arranging position specified by designation of the user in a predetermined storage region.

As explained above, as one aspect of the third embodiment, the server 10C that controls progress of a video game using the virtual space corresponding to the map information of a real space and the positional information of the user terminal is configured so as to include the determining unit 11, the changing unit 12C, the generating unit 13, and the specifying unit 14. Thus, the specifying unit 14 specifies the position in the virtual space that is designated by the user as the planned arranging position; and the changing unit 12C changes the position at which the event object is to be arranged or the position of the existing object on the basis of the specified planned arranging position. Therefore, as compared with a case where the user cannot designate the planned arranging position, it becomes possible to further heighten a degree of freedom in how the user influences on the position of the object while maintaining game balance.

### Fourth Embodiment

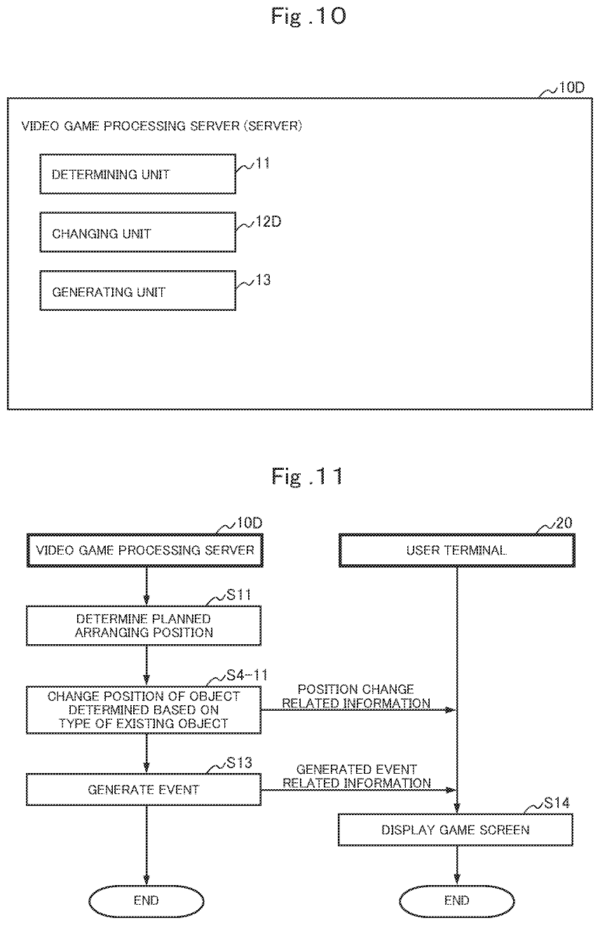

FIG. 10 is a block diagram illustrating a configuration of a video game processing server 10D (hereinafter, referred to as a “server 10D”), which is an example of the video game processing server 10. In the present embodiment, the server 10D at least includes a determining unit 11, a changing unit 12D, and a generating unit 13.

The changing unit 12D has a function to determine whether any position of an event object or an existing object is to be changed or not on the basis of a type of the existing object, and change the position that is determined to be changed on the basis of a planned arranging position.

Here, the, type of the existing object means a unit of existing objects that are classified in accordance with a predetermined standard. The type of the existing object is not limited particularly. However, it is preferable that a type of existing object can be recognized by the user. As examples of the type of the existing object, there are those classified in accordance with whether an event corresponding to an existing object exists or not, and those classified by a type of event corresponding to an existing object.

FIG. 11 is a flowchart illustrating an example of game processing executed by a video game processing system 100. Hereinafter, operations of the server 10D and a user terminal (hereinafter, referred to as a “terminal 20”) will be described as an example. In this regard, a flowchart illustrating an operation of each of the server 10D and the terminal 20 is omitted from a point of view to avoid repeated explanation.

When a planned arranging position is determined, the server 10D determines whether any position of an event object or an existing object is to be changed or not on the basis of a type of the existing object, and changes the position that is determined to be changed on the basis of the planned arranging position (Step S4-11). In the present embodiment, the server 10D transmits, to the terminal 20, position change related information for causing the terminal 20 to display a result of the change related to the change content of the position of the event object or the existing object.

As explained above, as one aspect of the fourth embodiment, the server 10D that controls progress of a video game using the virtual space corresponding to the map information of a real space and the positional information of the user terminal is configured so as to include the determining unit 11, the changing unit 12D, and the generating unit 13. Thus, the changing unit 12D determines whether any position of the event object or the existing object is to be changed or not on the basis of the type of the existing object, and changes the position that is determined to be changed on the basis of the planned arranging position. Therefore, it becomes possible to further maintain interest of a user in the video game.

### Fifth Embodiment

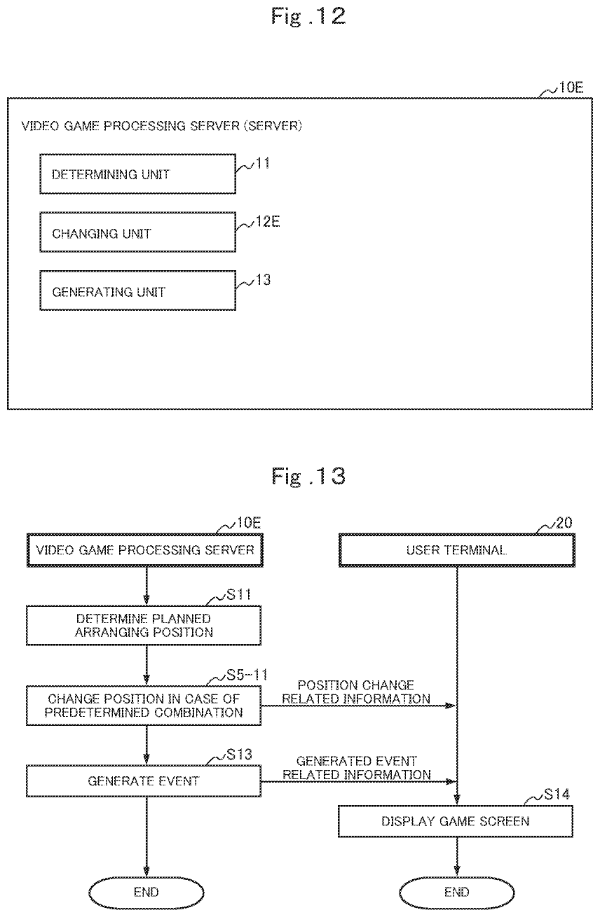

FIG. 12 is a block diagram illustrating a configuration of a video game processing server 10E (hereinafter, referred to as a “server 10E”), which is an example of the video game processing server 10. In the present embodiment, the server 10E at least includes a determining unit 11, a changing unit 12E, and a generating unit 13.

The changing unit 12E has a function to change a position at which an event object is to be arranged or a position of an existing object on the basis of a planned arranging position in a case where a combination of a type of the event object and a type of the existing object becomes a predetermined combination.

Here, the predetermined combination is not limited particularly. However, it is preferable that the predetermined combination is a combination in which a type of the event object is similar to a type of the existing object. As an example of the predetermined combination, there is a combination in which an event object and an existing object are respectively objects that indicate places related to corresponding events (for example, a town or a dungeon).

FIG. 13 is a flowchart illustrating an example of game processing executed by a video game processing system 100. Hereinafter, operations of the server 10E and a user terminal (hereinafter, referred to as a “terminal 20”) be described as an example. In this regard, a flowchart illustrating an operation of each of the server 10E and the terminal 20 is omitted from a point of view to avoid repeated explanation.

When a planned arranging position is determined, the server 10E changes a position at which an event object is to be arranged or a position of an existing object on the basis of a planned arranging position in a case where a combination of a type of the event object and a type of the existing object becomes a predetermined combination (Step S5-11). In the present embodiment, the server 101 transmits, to the terminal 20, position change related information for causing the terminal 20 to display a result of the change related to the change content of the position of the event object or the existing object.

As explained above, as one aspect of the fifth embodiment, the server 10E that controls progress of the video game using a virtual space corresponding to map information of a real space and positional information of the user terminal is configured so as to include the determining unit 11, the changing unit 12E, and the generating unit 13. Thus, the changing unit 12E changes the position at which the event object is to be arranged or the position of the existing object on the basis of the planned arranging position in a case where the combination of the type of the event object and the type of the existing object becomes the predetermined combination. Therefore, it becomes possible for a user to influence on the position of the object while giving priority to maintaining game balance. Namely, from the viewpoint from. maintaining of the game balance, it is possible for the user to roughly determine whether the position is to be changed or not in consideration of the type of the object.

### Sixth Embodiment

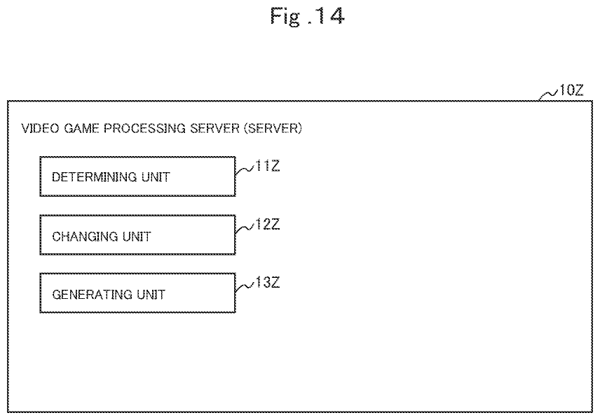

FIG. 14 is a block diagram illustrating a configuration of a video game processing server 10Z (hereinafter, referred to as a “server 10Z”), which is an example of the video game processing server 10 in the video game processing system 100 (see FIG. 1). In the present embodiment, the server 10Z at least includes a determining unit 11Z, a changing unit 12Z, and a generating unit 13Z.

The determining unit 11Z has function to determine a planned arranging position for an event object corresponding to an event that is selected on the basis of a user operation in a virtual space corresponding to map information on a real space

Here, the virtual space corresponding to the map information of the real space means a virtual space that is generated by using the map information of the real space. Hereinafter, a configuration in which a virtual space is generated by arranging objects corresponding to roads and buildings in a real space at positions corresponding to the real space will be described as an example.

Further, the user operation means an input operation to the user terminal 20 by the user. Hereinafter, a configuration in which the user terminal 20 is caused to display information regarding a plurality of events and a user is caused to carry out a selection input against any event on the basis of the displayed information will be described as an example. Hereinafter, a case where the user inputs selection of a guest in a video game will be described as an example.

Further, the event means any of various kinds of occurrences that can be generated in the video game. Hereinafter, a case where an event selected by a user operation is a quest for which a predetermined clear condition is defined will be described as an example.

Further, the event object means an object corresponding to an event and related to the event. Hereinafter, a case where an event object corresponds to a quest and is an object (or a destination) by which the quest is generated will be described as an example. In this regard, in the present embodiment, the destination has appearance related to the corresponding quest.

Further, the planned arranging position for the event object means a position where the event object is planned to be arranged in the virtual space. Hereinafter, a case where the user designates a planned arranging position for the destination will be described as an example.

The changing unit 12Z has a function to change a position at which the event object is to be arranged or a position of an existing object, which has already been arranged, on the basis of the planned arranging position.

Here, the existing object means an object that has already been arranged and is different from the event object. Hereinafter, a case where spots where a character of the user can be recovered or an item can be acquired, the character itself of the user, an enemy character, and a base of the user are arranged as the existing objects in a map as the virtual space will be described as an example. In this regard, in the present embodiment, the existing object may be a destination.

Further, the phrase “change a position of the object” means that a position. associated with an object is changed. Hereinafter, a case where a position of a destination or an existing object is changed when the user is caused to designate a position of a destination and the destination is displayed so as to overlap the existing object by displaying the destination at a user designation position will be described as an example. In the present embodiment, when the planned arranging position of the destination is designated to be displayed so that the destination overlaps with a spot, a position of the spot is changed so that the spot does not overlap with the destination. On the other hand, when the planned arranging position of the destination is designated to be displayed so that the destination overlaps with the character itself of the user or a base of the user, a position at which the destination is arranged is changed into a position where the destination does not overlap with the character itself of the user or the base of the user. In this regard, in the present embodiment, even though the planned arranging position of the destination is designated to be displayed so that the destination overlaps with another destination, the change in the position does not occur, and the two destinations are displayed so as to overlap with each other.

The generating unit 13Z has a function to generate an event in accordance with a positional condition regarding a position of the user terminal 20 and the position of the event object or the position of the existing object.

Here, the position of the user terminal 20 means a position indicated by positional information of the user terminal 20. The positional information of the user terminal 20 means information indicating a position in the real space. Hereinafter, a configuration in which positional information using a GPS signal is positional information of the user terminal 20 will be described as an example.

Further, the positional condition regarding the position of the user terminal 20 and the position of the event object or the position of the existing object means a condition that includes a state that the position of the user terminal 20 and the position of the arranged event object or the existing object have a predetermined relationship. Hereinafter, a case where the positional condition is that a distance between the character of the user and the destination or the existing object is a predetermined length or shorter will be described as an example. In this regard, the generating unit 13Z may be configured so that the event is generated in a case where a condition other than the positional condition is also satisfied. For example, the generating unit 13Z may be configured so that the event is generated in a case where the positional condition is satisfied and the user carries out a selection operation against the destination or the existing object.

Further, the event to be generated in accordance with the positional condition is not limited particularly. However, it is preferable that such an event an event corresponding to the event object or the existing object that satisfies the positional condition. In the present embodiment, the event corresponding to the destination is a quest. Further, in the present embodiment, an event corresponding to the spot is a recovery event of the character of the user or an item acquisition event, and an event corresponding to the base of the user is an event to confirm the inside of the base of the user.

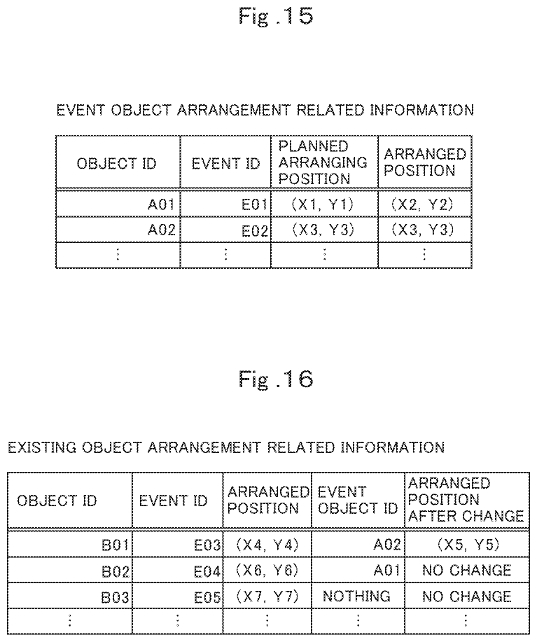

FIG. 15 is an explanatory drawing for explaining an example of a storage state of information stored in a storage unit (not illustrated in the drawings) included in the server 10Z. As illustrated in FIG. 15, the storage unit stores therein, as information regarding arrangement of event objects, an object ID, an event ID, a planned arranging position, and an arranged position so as to be associated with each other. Hereinafter, the information stored herein will be referred to as event object arrangement related information in order to be distinguished from the information regarding arrangement of existing objects.

Here, the object ID means information for identifying an event object.

Further, the event ID means information identifying an event.

Further, the planned arranging position means the planned arranging position determined by the determining unit 11Z. In the present embodiment, the planned arranging position is a coordinate of the planned arranging position of the event object identified by the object ID.

Further, the arranged position means a position at which the event object is arranged. In the present embodiment, since the position at which the event object is arranged may be changed by the changing unit 122, the position at which the event object is actually arranged is managed as the arranged position. In this regard, a relationship between the planned arranging position and the arranged position is not limited to the present embodiment, and the server 10Z may be configured so that the planned arranging position is updated to the arranged position.

FIG. 16 is an explanatory drawing for explaining an example of a storage state of information stored in the storage unit (not illustrated in the drawings) included in the server 102. As illustrated in FIG. 16, the storage unit stores therein, as information regarding arrangement of existing objects, an object ID, an event ID, an arranged position, an event object ID, and an arranged position after change so as to be associated with each other. Hereinafter, the information stored herein will be referred to as existing object arrangement related information in order to be distinguished from the information regarding arrangement of the event object.

Here, the object ID means information for identifying an existing object.

Further, the event ID means information identifying an event. In the present embodiment, the event is associated with the existing object. However, the event does not necessarily have to be associated with the existing object.

Further, the arranged position means a position at which the existing object identified by the object ID is arranged. In the present embodiment, the planned arranging position is a coordinate or the position at which the existing object identified by the object ID is arranged.

Further, the event object ID means information for identifying the event object. In the present embodiment, the event object ID corresponds to the object ID illustrated in FIG. 15, and is used in a case where an overlapping state by a plurality of objects is generated. Namely, in the present embodiment, in a case where it is not determined that the overlapping state is generated between the event object and the existing object identified by the information stored as the object ID illustrated in FIG. 16, the event object ID is not stored.

Further, the arranged position after change means a position that is to be arranged after change in a case where the position of the existing object identified by the object ID is changed. In the present embodiment, the position of the existing object is a position at which the existing object is arranged after change in a case where the position is changed by the changing unit 12Z. In this regard, a relationship between the arranged position and the arranged position after change is not limited to the present embodiment, and the server 10Z may be configured so that the arranged position is updated.

In this regard, the information regarding arrangement of the event object and the information regarding arrangement of the existing objects may be managed in separate databases for the purpose of distinction as described above, but may be managed in the same database.

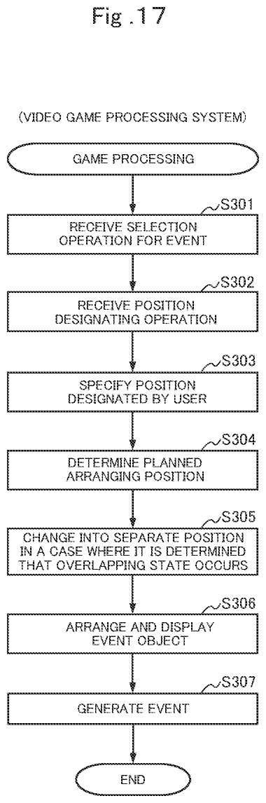

FIG. 17 is a flowchart illustrating an example of game processing executed by user's a video game processing system 100Z (hereinafter, referred to as a “system 100Z”) provided with the server 10Z. In the game processing according to the present embodiment, processes related to a control of progress of a video game using the positional information of the user terminal 20 (hereinafter, referred to as the “terminal 20”) in response to an operation of the user are executed. Hereinafter, each of the processes will be described. In this regard, the order of the processes may be changed without any contradiction or the like of processing content.

The game processing is started as an opportunity, that the terminal 20 accessing the server 10Z requests display of a came screen, for example.

In the game processing, the system 100Z first receives a selection operation for an event by the user (Step S301). In the present embodiment, the system 1002 receives a selection operation against information regarding a plurality of events, which is displayed on a game screen, from the user.

When the selection operation for the event is received, the system 100Z receives a position designating operation by the user (Step S302). In the present embodiment, the system 100Z receives a selection operation for a position on a map of a virtual space, which is displayed on the game screen, from the user.

When the position designating operation is received, the system 100Z specifies a position in the virtual space on the basis of the received position designating operation (Step S303). In the present embodiment, the system 100Z specifies a position in the virtual space on the basis of the position for which designation on the map of the virtual space is received.

When the position the virtual space is specified, the system 100Z determines a planned arranging position of an event object corresponding to the event selected on the basis of a user operation in the virtual space corresponding to map information on a real space (Step S304). In the present embodiment, the system 100Z determines the specified position as the planned arranging position of the destination.

In a case where it is determined that a predetermined state where the event object and the existing object are displayed so that at least a part of the event object overlaps with the existing object by displaying the event object at the planned arranging position after the planned arranging position is determined, the system 100Z changes the position at which the event object is arranged or the position of the existing object into a position at which the event object and the existing object are separated from each other on the basis of the planned arranging position (Step S305). In the present embodiment, when it is designated to display the destination and the spot so as to overlap with each other, the system 100Z changes the planned arranging position of the destination into the position where the spot does not overlap with the destination.

When the position at which the event object is arranged or the position of the existing object is changed, the system 100Z causes the terminal 20 to arrange and display the event object (Step S306). In the present embodiment, the system 100Z causes the terminal 20 to arrange and display the destination.

When the event object is arranged and displayed, the system 100Z generates an event in accordance with a positional condition regarding the position of the terminal 20 and the position of the event object or the position of the existing object (Step S307). In the present embodiment, the system 100Z starts a quest corresponding to the destination in a case where the user carries out a selection operation against a destination where a distance from the character of the user is a predetermined length or shorter.

In the present embodiment, when the event is generated, the system 100Z terminates the processes herein.

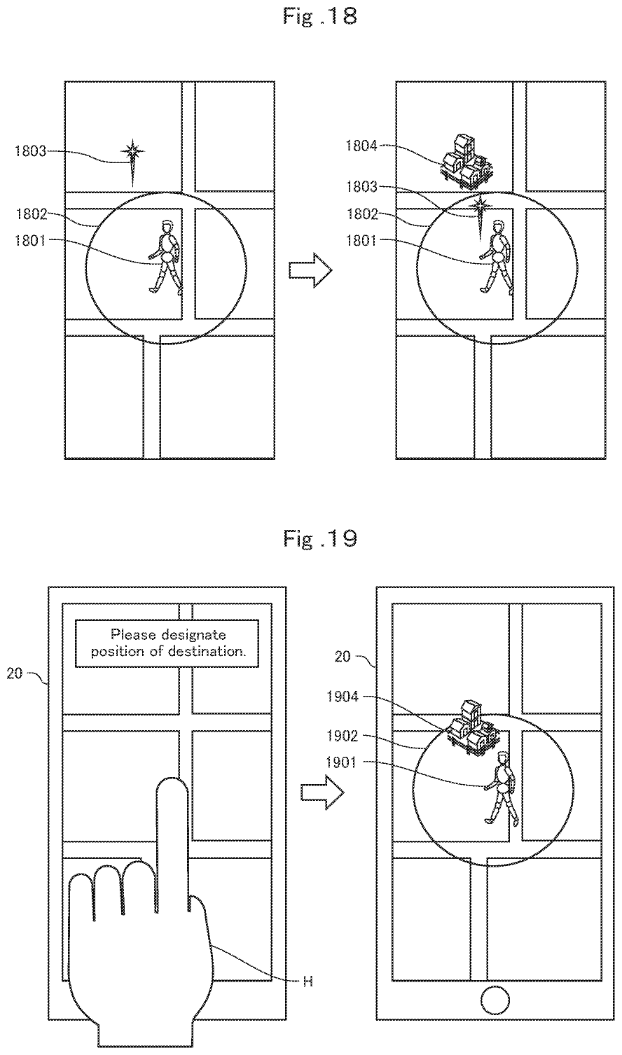

FIG. 18 is an explanatory drawing for explaining an example of the game screen on a display screen. A character 1801 of a user, an event generable area 1802 based on a position of the character 1801, and a spot 1803 are illustrated in a game screen at a left side of FIG. 18.

The character 1801 is an image that indicates a character of the user, and is displayed at a location near the center of the display screen. Further, the character 1801 is displayed at a position in a virtual space corresponding to the positional information of the terminal 20. When a position of the terminal 20 changes in a real space, the character 1801 moves in the virtual space in the similar manner. Further, the event generable area 1802 also moves in accordance with movement of the character 1801.

The event generable area 1802 is an area that satisfies a positional condition, which is included in conditions based on which an event corresponding to an object is generated. The positional condition is a condition that the position of the terminal 20 and a position of the object have a predetermined relationship.

The spot 1803 is an object against which the user carries out a touch operation in a state where the spot 1803 exists within the event generable area 1802, whereby a recovery event or an item acquisition event is generated. In the left side of FIG. 18, the spot 1803 exists outside the event generable area 1802. Therefore, even though the user carries out the touch operation, the recovery event or the item acquisition event is not generated.

The character 1801 of the user, the event generable area 1802, the spot 1803, and a destination 1804 are illustrated in a game screen at a right side of FIG. 18. The right side of FIG. 18 is the game screen when the user designates a planned arranging position of the destination 1804 in a state of the left side of FIG. 18 so that the destination 1804 overlaps with the spot 1803. Here, it is determined that a state where the destination 1804 and the spot 1803 are displayed so as to overlap with each other is generated on the basis of the planned arranging position of the destination 1804, and a position of the spot 1803 is to be changed. On the other hand, the destination 1804 is arranged at the planned arranging position designated by the user. The position of the spot 1803 after change exists within the event generable area 1802. In other words, the spot 1803 moves from the outside of the event generable area 1802 to the inside thereof by arrangement of the destination 1804. Namely, the arrangement of the destination 1804 allows the user to generate an event corresponding to the spot 1803 without moving the character 1801. In this regard, the game screen may be configured so that appearance of the spot 1803 changes depending upon whether the spot 1803 is positioned within the event generable area 1802 or not.

FIG. 19 is an explanatory drawing for explaining an example of a game screen. The terminal 20 displaying a game screen and a hand H of a user who carries out a selection operation for a planned arranging position of a destination against another terminal 20 are illustrated at a left side of FIG. 19.

A character 1901 of the user, an event generable area 1902, a spot 1903, and a destination 1904 are illustrated in a game screen at a right side of FIG. 19. The character 1901 to the destination 1904 respectively correspond to the character 1801 to the destination 1804. In the right side of FIG. 19, the terminal 20 displays a game screen of a state where the destination 1904 is arranged on the basis of the planned arranging position selected at the left side of FIG. 19. Here, the destination 1904 is arranged at a different position from the planned arranging position. In this regard, the server 10Z may be configured so as to change the position at which the destination 1904 is arranged even in a case where a position at which a state where the destination 1904 is displayed so as to overlap not only the character 1901 but also a base of the user is generated is designated as the planned arranging position of the destination 1904.

As explained above, as one aspect of the sixth embodiment, the server 10Z that controls progress of the video game using the virtual space corresponding to the map information of a real space and the positional information of the user terminal is configured so as to include the determining unit 11Z, the changing unit 12Z, and the generating unit 13Z. Thus, the determining unit 11Z determines the planned arranging position of the event object corresponding to the event that is selected on the basis of the user operation in the virtual space corresponding to the map information on the real space; the changing unit 12Z changes the position at which the event object is to be arranged or the position of the existing object, which has already been arranged, on the basis of the planned arranging position; and the generating unit 13Z generates the event in accordance with the positional condition regarding the position of the terminal 20 and the position of the event object or the position of the existing object. Therefore, it becomes possible to prevent interest of the user in the video game from being decreased.

Namely, in the video game using the positional information of the terminal 20, it is possible to reflect intention of the user to the change in the position of the object by arrangement of the event object (for example, the destination), and as a result, it becomes possible to prevent the interest of the user in the video game from being decreased. In other words, in the video game using the positional information of the terminal 20, it is possible to cause the user to experience a sense to affect the configuration of the virtual space by the change in the position of the object, and as a result, it becomes possible to cause the user to continuously have interest in the video game.

Further, in the example of the sixth embodiment described above, the server 10Z may be configured so as to change the position at which the event object is to be arranged or the position of the existing object into a position at which the event object and the existing object are separated from each other on the basis of the planned arranging position in a case where it is determined that a predetermined state is generated, the predetermined state being a state where the event object and the existing object are displayed so that at least a part of the event object overlaps with the existing object by displaying the event object at the planned arranging position. Therefore, it becomes possible to improve visibility of the displayed object from the user and operability in a case where the user carries out an operation to directly select the displayed object, for example.

Namely, in the video game using the positional information of the terminal 20, it becomes possible to improve operability and visibility by shifting any of the event object (for example, the destination) and the existing object (for example, the spot) when they overlap with each other. Further, in the video game using the positional information of the terminal 20, for example, even in a case where the user who carries the terminal 20 cannot move and cannot thus satisfy a positional condition of an event of an object, it is possible to set to a state where the positional condition is satisfied by shifting the object, and as a result, it becomes possible to motivate the user to actively play the video game.

Further, in the example of the sixth embodiment described above, the server 10Z may be configured so as to specify the position in the virtual space that is designated by the user as the planned arranging position and change the position at which the event object is to be arranged or the position of the existing object on the basis of the specified planned arranging position Therefore, as compared with a case where the user cannot designate the planned arranging position, it becomes possible to further heighten a degree of freedom in how the user influences on the position of the object while maintaining game balance.

Further, in the example of the sixth embodiment described above, the server 10Z may be configured so as to determine whether any position or an event object or an existing object is to be changed or not on the basis of a type or the existing object and change the position that is determined to be changed on the basis of the planned arranging position. Therefore, it becomes possible to further maintain interest or the user in the video game.

Further, in the example of the sixth embodiment described above, the server 10Z may be configured so as to change a position at which the event object is to be arranged or a position of the existing object on the basis of the planned arranging position in a case where a combination of a type of the event object and a type of the existing object becomes a predetermined combination. Therefore, it becomes possible for the user to influence on the position of the object while giving priority to maintaining game balance.

Further, it has not been mentioned particularly in the example of the sixth embodiment described above However, the server 10Z may be configured so as to reflect a change result of the position at which the event object is to be arranged or the position of the existing object to any of the other users. Here, the other users mean users different from one user who uses the terminal 20. Namely, the other users mean users different from each of the users himself or herself. In this regard, it is preferable that each of the other users uses any of user terminals 201 to 20N different from the terminal 20 of the user. Further, the phrase “reflect a change result to any of the other users” means that an influence based on a change result is given to a game screen displayed by a user terminal 20 of the other user. By configuring the sever 10Z in this manner, for example, it is possible for the user to experience a sense to influence on the position of the object arranged in the virtual space shared with the other user, and as a result, it becomes possible to cause the user to experience a sense of unity with the other user.

Further, it has not been mentioned particularly in the example of the sixth embodiment described above. However, the server 10Z may be configured so as to: determine a planned arranging position of the other event object in a case where the other event object is further selected on the basis of a user operation in a state where one event object is arranged; and further change the position of the existing object that is arranged at the changed position on the basis of the planned arranging position of the other event object. Here, the phrase “further change the position of the existing object that is arranged at the changed position” means that the position is further changed from the position of the existing object after change based on the planned arranging position of the event object to a different position. A configuration to further change the position of the existing object that is arranged at the changed position is not limited particularly. However, it is preferable that the position after further change is determined on the basis of the changed position. In the example described above, the server 10Z may be configured so that after the destination is arranged and displayed, a planned arranging position of another destination is displayed so as to overlap with a spot at the position after change by arrangement of the destination. By configuring the sever 107 in this manner, it becomes possible for the user to change the position of the existing object more freely.

Further, it has not been mentioned particularly in the example of the sixth embodiment described above. However, the server 10Z may be configured so as to restore the position of the existing object changed by arrangement of the event object to the position before change in a case where an arrangement state of the event object is cancelled. Here, the arrangement state of the event object means a state where the event object is arranged in the virtual space. Further, the phrase “the arrangement state of the event object is cancelled” means that the event object changes from a state where the event object is arranged in the virtual space to a state where the event object is not arranged in the virtual space. A configuration to cancel the arrangement state of the event object is not limited particularly. However, it is preferable that the server 10Z is configured so as to determine cancellation of the arrangement state of the event object on the basis of a user operation. In this regard, the cancellation of the arrangement state of the event object may be withdrawn on the basis of a further user operation. Namely, the server 10Z may be configured so that the event object is arranged in the virtual space on the basis of the further user operation in a case where the arrangement state is cancelled. In the example described above, the server 10Z may be configured so as to manage quests each of which can be selected by the user in a group (or a chapter) and that are divided by every plural quests. In this configuration, destinations corresponding to quests in a chapter selected by the user may become the arrangement state. In a case where the user changes chapters to be selected, the arrangement state of destinations corresponding to quests of a chapter before change are cancelled. By configuring the sever 10Z in this manner, it is possible to return to the position of the existing object intended by the developer, and this makes it possible to maintain game balance more easily.

Further, it has not been mentioned particularly in the example of the sixth embodiment described above. However, the server 10Z may be configured so as not to restore the position of the existing object, which is changed by arrangement of the event object, and to keep the changed position in a case where the arrangement state of the event object is cancelled and a predetermined keeping condition is satisfied. Here, the keeping condition means a condition that the changed position of the existing object is kept even in a case where the arrangement state of the event object is cancelled. The keeping condition is not limited particularly. However, it is preferable that the keeping condition is a condition that is satisfied on the basis of a user operation. In the example described above, the server 10Z may be configured so as not to restore a spot whose position is changed by arrangement of the destination to a position before change and to keep a position after change even in a case where an arrangement state of a destination corresponding to a quest is cancelled by clearing the quest. By configuring the sever 10Z in this manner, when the arrangement state of the event object is cancelled, the position of the existing object is not restored uniformly, it becomes possible to adjust improvement of the user's taste and maintenance of game balance flexibly.

As explained above, one shortage or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, and 201 to 20N and the server 10 executes the various kinds of processing described above in accordance with various kinds of control programs (for example, a video game processing program) stored in the storage device with which the corresponding terminal or server is provided.

Further, the configuration of the video game processing system 100 is not limited to the configuration that has been explained as an example of each of the embodiments described above. For example, the system 100 may be configured so that the server 10 executes a part or all of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a part or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that the program causes a single apparatus to perform a part or all of the functions that have been explained as the example of each of the embodiments described above without including a communication network.

(Appendix)

The explanation of the embodiments described above has been described so that the following inventions can be at least performed by a person having a normal skill in the art to which the present invention belongs.

(1)

A non-transitory computer-readable medium including a video game processing program for causing a server to perform functions to control progress of a video game using positional information of a user terminal of a user in response to a user operation, the functions comprising:

a determining function configured to determine a planned arranging position for an event object corresponding to an event in a virtual space corresponding to map information on a real space, the event being selected on a basis of the user operation, the planned arranging position for the event object being a position at which the event object is planned to be arranged;

a changing function configured to change a position at which the event object is to be arranged or a position of an existing object on a basis of the planned arranging position, the existing object having already been arranged; and

a generating function configured to generate an event in accordance with a positional condition regarding a position of the user terminal and the position of the event object or the position of the existing object.

(2)

The non-transitory computer-readable medium according to (1),

wherein the changing function includes a function configured to change the position at which the event object is to be arranged or the position of the existing object into a position at which the event object and the existing object are separated from each other on the basis of the planned arranging position in a case where it is determined that a predetermined state is generated, the predetermined state being a state where the event object and the existing object are displayed so that at least a part of the event object overlaps with the existing object by displaying the event object at the planned arranging position.

(3)

The non-transitory computer-readable medium according to (1) or (2), the functions further comprising:

a specifying function configured to specify a position in the virtual space, which is designated by the user, as the planned arranging position,

wherein the changing function includes a function configured to change the position at which the event object is to be arranged or the position of the existing object on a basis of the specified planned arranging position

The non-transitory computer-readable medium according to any one of (1) to (3),

wherein the chancing function includes a function configured to determine whether any position of the event object or the existing object is to be changed on a basis of a type of the existing object, and change the position that is determined to be changed on the basis of the planned arranging position.

The non-transitory computer-readable medium. according to any one of (1) to (4),

wherein the changing function includes a function configured to change the position at which the event object is to be arranged or the position of the existing object on the basis of the planned arranging position in a case where a combination of a type of the event object and a type of the existing object becomes a predetermined combination.

(6)

The non-transitory computer-readable medium according to any one of (1) to (5), the functions further comprising:

a reflecting function configured to reflect a change result of the position at which the event object is to be arranged or the position of the existing object by the changing function to any of the other users.

(7)

A non-transitory computer-readable medium including a video game processing program for causing a user terminal to perform at least one function of the functions that the video game processing program described in any one of (1) to (6) causes the server to perform, the user terminal being capable of communicating with the server.

(8)

A video game processing system for controlling progress of a video game using positional, information of a user terminal of a user in response to a user operation, the video game processing system comprising a communication network, a server, and the user terminal, the video game processing system further comprising:

a determiner configured to determine a planned arranging position for an event object corresponding to an event in a virtual space corresponding to map information on a real space, the event being selected on a basis of the user operation, the planned arranging position for the event object being a position at which the event object is planned to be arranged;

a changer configured to change a position at which the event object is to be arranged or a position of an existing object on a basis of the planned arranging position, the existing object having already been arranged; and

a generator configured to generate an event in accordance with a positional condition regarding a position of the user terminal and the position of the event object or the position of the existing object.

(9)

The video game processing system according to (8),

wherein the server includes the determiner, the changer, and the generator, and

wherein the user terminal includes an output controller configured to output a game screen to a display screen of a display device, the game screen indicating a state that the event is generated by the generator.

A non-transitory computer-readable medium including a video game processing program for causing a user terminal to perform functions to control progress of a video game using positional information of a user terminal of a user in response to the user operation, the functions comprising:

a determining function configured to determine a planned arranging position for an event object corresponding to an event in a virtual space corresponding to map information on a real space, the event being selected on a basis of the user operation, the planned arranging position for the event object being a position at which the event object is planned to be arranged;

a changing function configured to change a position at which the event object is to be arranged or a position of an existing object on a basis of the planned arranging position, the existing object having already been arranged; and

a generating function configured to generate an event in accordance with a positional condition regarding a position of the user terminal and the position of the event object or the position of the existing object.

(11)

A video game processing method of controlling progress of a video game using positional information of a user terminal of a user in response to a user operation, the video game processing method comprising:

a determining process configured to determine a planned arranging position for an event object corresponding to an event in a virtual space corresponding to map information on a real space, the event being selected on a basis of the user operation, the planned arranging position for the event object being a position at which the event object is planned to be arranged;

a changing process configured to change a position at which the event object is to be arranged or a position of an existing object on a basis of the planned arranging position, the existing object having already been arranged; and

a generating process configured to generate an event in accordance with a positional condition regarding a position of the user terminal and the position of the event object or the position of the existing object.

(12)

A video game processing method of controlling progress of a video game by a video game processing system using positional information of a user terminal of a user in response to a user operation, the video game processing system comprising a communication network, a server, and the user terminal, the video game processing method comprising:

a determining process configured to determine a planned arranging position for an event object corresponding to an event in a virtual space corresponding to map information on a real space, the event being selected on a basis of the user operation, the planned arranging position for the event object being a position at which the event object is planned to be arranged;

a changing process configured to change a position at which the event object is to be arranged or a position of an existing object on a basis of the planned arranging position, the existing object having already been arranged; and

a generating process configured to generate an event in accordance with a positional condition regarding a position of the user terminal and the position of the event object or the position of the existing object.

### INDUSTRIAL APPLICABILITY

According to one of the embodiments of the present disclosure, it is useful to allow to prevent a user from losing interest in a video game.

What is claimed is:

1. A non-transitory computer-readable medium storing a video game processing program for causing a computer of a server to perform functions comprising:
controlling progress of a video game using positional information of a user terminal of a user in response to a user operation;
determining a planned position for an event object planned to be placed in a virtual space corresponding to map information on a real space, the event object corresponding to an event being selected based on the user operation;
changing a position at which the event object is to be placed or a position of an existing object which has already been placed based on the planned position; and
generating an event in accordance with a positional condition regarding a position of the user terminal and either the position of the event object or the position of the existing object.

2. The non-transitory computer-readable medium according to claim 1,
wherein the changing the position includes changing either the position at which the event object is to be placed or the position of the existing object based on the planned position in order to set the event object and the existing object apart from each other, if it is determined that the event object and the existing object are to be displayed in a manner at least a part of the existing object is to overlap with at least a part of the event object at the planned position.

3. The non-transitory computer-readable medium according to claim 1, the functions further comprising:
specifying a position in the virtual space designated by the user, as the planned position,
wherein the changing a position includes changing the position at which the event object is to be placed or the position of the existing object based on the planned position specified.

4. The non-transitory computer-readable medium according to claim 1,
wherein the changing a position includes determining whether any position of the event object or the existing object is to be changed based on a type of the existing object, and changing the position that is determined to be changed based on the planned position.

5. The non-transitory computer-readable medium according to claim 1,
wherein the changing a position includes changing the position at which the event object is to be placed or the position of the existing object based on the planned position if a combination of a type of the event object and a type of the existing object becomes a predetermined combination.

6. The non-transitory computer-readable medium according to claim 1, the functions further comprising:
reflecting a change result of the position at which the event object is to be placed. or the position of the existing object by the changing a position to any of the other users.

7. A video game processing system comprising:
a communication network;
a server;
a user terminal; and
a computer configured to:
control progress of a video game using positional information of the user terminal of a user in response to a user operation;
determine a planned position for an event object planned to be placed in a virtual space corresponding to map information on a real space, the event object corresponding to an event being selected based on the user operation;
change a position at which the event object is to be placed or a position of an existing object which has already been placed based on the planned position; and
generate an event in accordance with a positional condition regarding a position of the user terminal and either the position of the event object or the position of the existing object.

8. A non-transitory computer-readable medium including a video game processing program configured to cause a computer of a user terminal to perform functions, comprising:
controlling progress of a video game using positional information of a user terminal of a user in response to the user operation;
determining a planned position for an event object planned to be placed in a virtual space corresponding to map information on a real space, the event object corresponding to an event being selected based on the user operation;
changing a position at which the event object is to be placed or a position of an existing object which has already been placed based on the planned position; and
generating an event in accordance with a positional condition regarding a position of the user terminal and either the position of the event object or the position of the existing object.
